(19) United States
(12) Patent Application Publication
(10) Pub. No.: US 2026/0133359 A1
(43) Pub. Date: May 14, 2026

(54) ILLUMINATION DEVICE AND DISPLAY DEVICE

(71) Applicant: Magnolia White Corporation, Tokyo (JP)

(72) Inventors: Koji FUJISAWA, Tokyo (JP); Ken KAGABU, Tokyo (JP); Koichi OKUDA, Tokyo (JP); Hiroaki KIJIMA, Tokyo (JP)

(73) Assignee: Magnolia White Corporation, Tokyo (JP)

(21) Appl. No.: 19/387,681

(22) Filed: Nov. 13, 2025

(30) Foreign Application Priority Data
Nov. 13, 2024 (JP) 2024-197806

(51) Int. Cl. F21V 8/00

(52) U.S. Cl. CPC G02B 6/0045; G02B 6/0053; G02B 6/0055; G02B 6/0068; G02B 6/0091

(57) ABSTRACT

According to an embodiment, in an illumination device the first surface of the light guide includes a plurality of first protruding portions formed thereon. The second surface includes a plurality of second protruding portions formed thereon. Each of the plurality of first protruding portions has a cross-sectional shape of a first triangle projecting downward, and, has a first base angle, a second base angle, and a first apex angle. Each of the plurality of second protruding portions has a cross-sectional shape of a second triangle projecting upward, and, has a third base angle, a fourth base angle, and a second apex angle. The third base angle is larger than the first base angle.

### CROSS-REFERENCE TO RELATED APPLICATION

This application is based upon and claims the benefit of priority from Japanese Patent Application No. 2024-197806, filed Nov. 13, 2024, the entire contents of which are incorporated herein by reference.

### FIELD

Embodiments described herein relate generally to an illumination device and a display device.

### BACKGROUND

Illumination devices for illuminating display panels have been developed.

### BRIEF DESCRIPTION OF THE DRAWINGS

FIG. 1 is a perspective view schematically showing a configuration of a display device according to an embodiment.

FIG. 2 is a plan view schematically showing the configuration of the display device.

FIG. 3 is a cross-sectional view showing a sectional configuration of the display device taken along the line A1-A2 in FIG. 2.

FIG. 4 is a cross-sectional view schematically showing a configuration of an illumination device of a comparative example.

FIG. 5 is a cross-sectional view showing a protruding portion provided on a light guide.

FIG. 6 is a cross-sectional view schematically showing a configuration of an illumination device of the embodiment.

FIG. 7 is a cross-sectional view showing a protruding portion provided on the light guide.

FIG. 8 is a cross-sectional view showing another configuration example of the illumination device in the embodiment.

FIG. 9 is a cross-sectional view showing a protruding portion provided on the light guide.

FIG. 10 is a plan view illustrating an application example of the illumination device.

FIG. 11 is a cross-sectional view showing a cross-sectional configuration of the display device taken along the line B1-B2 in FIG. 10.

FIG. 12 is a perspective view showing an example of an appearance of a display device according to Configuration Example 3.

### DETAILED DESCRIPTION

In general, according to one embodiment, an illumination device comprises
a light guide including a first edge and a second edge;
a plurality of light source elements disposed to face the first edge;
a first reflector provided below the light guide;
an optical sheet provided on the light guide; and
a second reflector provided in contact with the second edge,
wherein
the light guide has a cross-sectional shape of a trapezoid whose upper base is shorter than a lower base,
the light guide includes a first surface facing the first reflector and a second surface facing the optical sheet,
the first surface includes a plurality of first protruding portions formed thereon,
the second surface includes a plurality of second protruding portions formed thereon,
each of the plurality of first protruding portions has a cross-sectional shape of a first triangle projecting downward,
each of the plurality of first protruding portions has a first base angle, a second base angle, and a first apex angle,
each of the plurality of second protruding portions has a cross-sectional shape of a second triangle projecting upward,
each of the plurality of second protruding portions has a third base angle, a fourth base angle, and a second apex angle,
the third base angle is larger than the first base angle.

According to another embodiment, an illumination device comprises
a light guide including a first edge and a second edge;
a plurality of light source elements disposed to face the first edge;
a first reflector provided below the light guide; and
an optical sheet provided on the second light guide; and
a second reflector provided in contact with the second edge,
wherein
the light guide has a cross-sectional shape of a trapezoid whose upper base is shorter than a lower base,
the light guide includes a first surface facing the first reflector and a second surface facing the optical sheet,
the first surface includes a plurality of first protruding portions formed thereon,
the second surface includes a plurality of second protruding portions formed thereon,
each of the plurality of first protruding portions has a cross-sectional shape of a first triangle projecting downward,
each of the plurality of first protruding portions has a first base angle, a second base angle, and a first apex angle,
each of the plurality of second protruding portions has a cross-sectional shape of a second triangle projecting upward,
each of the plurality of second protruding portions has a third base angle, a fourth base angle, and a second apex angle, and
the third base angle and the first base angle are equal to each other.

An object of this embodiment is to provide an illumination device with improved light extraction efficiency. With such an illumination device provided, it is possible to provide a display device with high brightness.

Embodiments will be described hereinafter with reference to the accompanying drawings. Note that the disclosure is merely an example, and proper changes within the spirit of the invention, which are easily conceivable by a skilled person, are included in the scope of the invention as a matter of course. In addition, in some cases, in order to make the description clearer, the widths, thicknesses, shapes, etc., of the respective parts are schematically illustrated in the drawings, compared to the actual modes. However, the schematic illustration is merely an example, and adds no restrictions to the interpretation of the invention. Besides, in the specification and drawings, the same or similar elements as or to those described in connection with preceding drawings or those exhibiting similar functions are denoted by like reference numerals, and a detailed description thereof is omitted unless otherwise necessary.

The embodiments described herein are not general ones, but rather embodiments that illustrate the same or corresponding special technical features of the invention. The following is a detailed description of one embodiment of a display device with reference to the drawings.

In this embodiment, a first direction X, a second direction Y and a third direction Z are orthogonal to each other, but may intersect at an angle other than 90 degrees. The direction toward the tip of the arrow in the third direction Z is defined as up or above, and the direction opposite to the direction toward the tip of the arrow in the third direction Z is defined as down or below. Note that the first direction X, the second direction Y and the third direction Z may as well be referred to as an X direction, a Y direction and a Z direction, respectively.

With such expressions as “the second member above the first member” and “the second member below the first member”, the second member may be in contact with the first member or may be located away from the first member. In the latter case, a third member may be interposed between the first member and the second member. On the other hand, with such expressions as “the second member on the first member” and “the second member beneath the first member”, the second member is in contact with the first member.

Further, it is assumed that there is an observation position to observe the illumination device on a tip side of the arrow in the third direction Z. Here, viewing from this observation position toward the X-Y plane defined by the first direction X and the second direction Y is referred to as plan view. Viewing a cross-section of the illumination device in the X-Z plane defined by the first direction X and the third direction Z or in the Y-Z plane defined by the second direction Y and the third direction Z is referred to as cross-sectional view.

### Embodiment 1

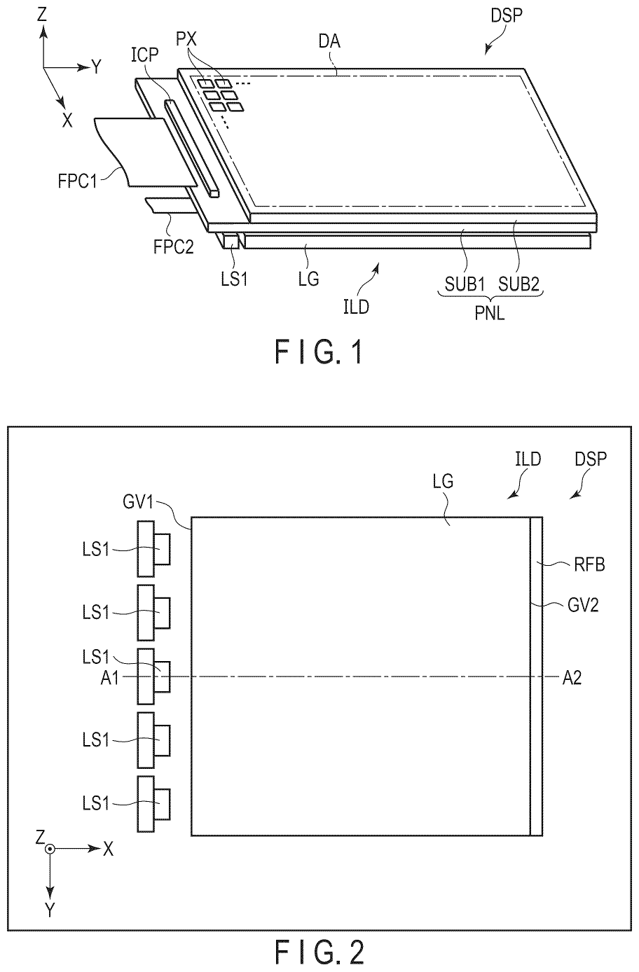

FIG. 1 is a perspective view schematically showing a configuration of a display device according to the embodiment. A display device DSP comprises a display panel PNL, an illumination device ILD, a drive IC chip ICP for driving the display panel PNL, a flexible printed circuit board FPC1 for supplying control signals to the display panel PNL, and a flexible printed circuit board FPC2 for supplying control signals to the illumination device ILD. For example, the flexible printed circuit board FPC1 and the flexible printed circuit board FPC2 may be connected to a control module that controls the operation of the display panel PNL and the illumination device ILD.

The display panel PNL comprises a substrate SUB1 (array substrate) and a substrate SUB2 (counter substrate) facing the substrate SUB1. The display panel PNL has a display area DA for displaying images. The display panel PNL comprises a plurality of pixels PX arranged in a matrix in the display area DA, for example.

The illumination device ILD includes a light source element LS1 and a light guide LG facing the substrate SUB1. The light source element LS1 faces one of side surfaces of the light guide LG. FIG. 1 shows one light source element LS1, but a plurality of light source elements LS1 may be provided.

In the configuration example shown in FIG. 1, the substrate SUB1, the substrate SUB2, and the light guide LG each have short edges along the first direction X and long edges along the second direction Y, and their shape in plan view is rectangular. Note that the shape of the substrate SUB1, the substrate SUB2, and the light guide LG is not limited to this; the shape in plan view may be some other shape such as square or circular.

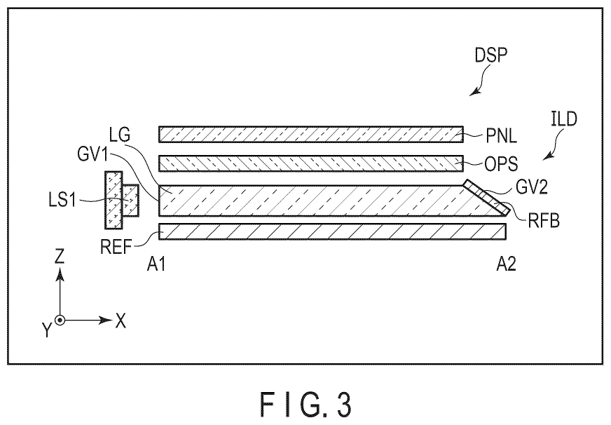

FIG. 2 is a plan view schematically showing a configuration of the display device. FIG. 3 is a cross-sectional view showing a cross-sectional structure of the display device taken along the line A1-A2 in FIG. 2.

The display device DSP comprises an illumination device ILD and a display panel PNL. The illumination device ILD comprises a reflector REF, a light guide LGL, a reflector RFB, an optical sheet OPS, and a light source element LS1. The reflector REF, the light guide LG, and the optical sheet OPS are stacked in this order. The display panel PNL is provided on the illumination device ILD.

In a plan view, the edges extending along the second direction Y of the light guide LG are designated as an edge GV1 and an edge GV2, respectively. In FIG. 2, the edge on the left side of the page is the edge GV1, and the edge on the right side of the page is the edge GV2. The light source element LS1 is provided at a position so face the edge GV1 of the light guide LG. The reflector RFB is provided to be in contact with the edge GV2 of the light guide LG.

The light guide plate LG has a rectangular shape in a plan view and a trapezoidal shape in a cross-sectional view, having a lower base thereof is longer than an upper base. The edge GV1, which is a left side of this trapezoidal shape, extends along the third direction Z. The edge GV2, which is a right side of this trapezoidal shape, extends to be inclined with respect to the third direction Z.

The light source element LS1 is provided to face the edge GV1 of the light guide LG. Light emitted from the light source element LS1 is incident onto the edge GV1 of the light guide LG.

Note that the edges GV1 and GVL1 are referred to as edges, but they are actually surfaces parallel to the Y-Z plane. The edge GV2 is actually a surface inclined obliquely relative to the Y-Z plane.

On the main surfaces of the light guide LGL, the light guide LG and the optical sheet OPS, multiple protruding portions (which may as well be referred to as prisms) are provided.

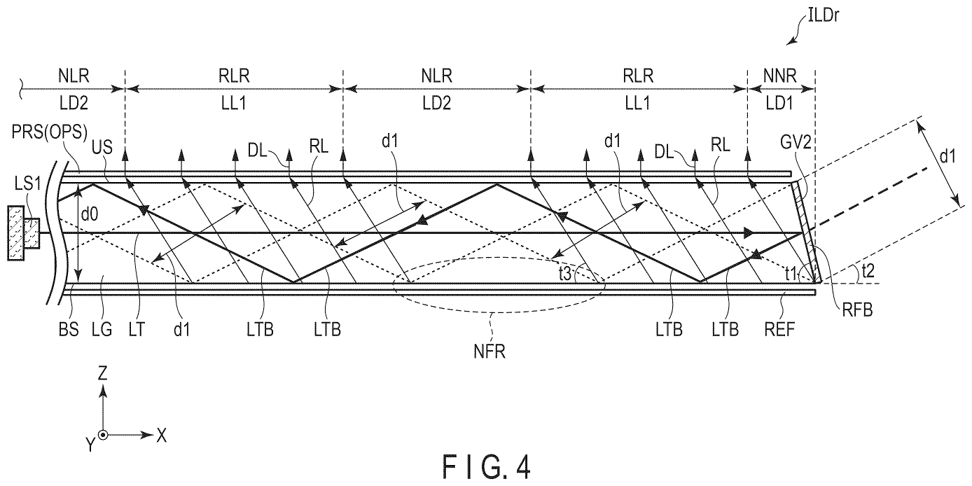

FIG. 4 is a cross-sectional view schematically showing a configuration of an illumination device of a comparative example. The illumination device ILDr shown in FIG. 4 comprises a reflector REF, a light guide LG, a reflector REB, a prism sheet PRS, and a light source element LS1. The optical sheet OPS shown in FIG. 3 corresponds to the prism sheet PRS shown in FIG. 4. Note here that the configuration of the optical sheet OPS is not limited to this, and it may as well include an optical sheet other than a prism sheet.

Of the main surfaces of the light guide LG, the surface facing the reflector REF is designated as a surface BS. Of the main surfaces of the light guide LG, the surface facing the prism sheet PRS is designated as a surface US.

The thickness of the light guide LG (length along the third direction Z) is defined as a thickness d0. It is assumed here that the light beam width d1 is the same as the thickness d0 (d1=d0).

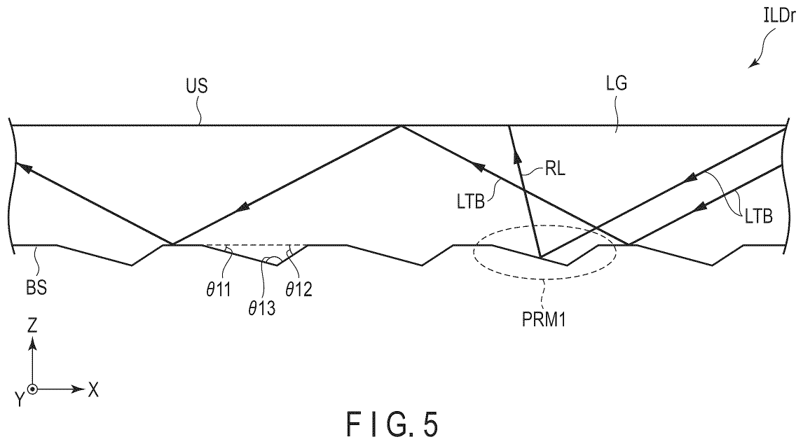

FIG. 5 is a cross-sectional view showing a protruding portion provided on the light guide LG. On the surface BS of the light guide LG, a protruding portion PRM1 protruding out downward (opposite to the third direction Z) is provided. On the other hand, no protruding portion is provided on the surface US of the light guide LG.

The protruding portion PRM1 is, as described above, a portion protruding out downward. Of the base angles of the protruding portion PRM1, the angle on the left side of the page is denoted as an angle θ11, and the angle on the right side of the page is denoted as an angle θ12. The apex angle of the protruding portion PRM1 is denoted as an angle θ13. The angles θ11, θ12, and θ13 may be different from each other. In the example shown in FIG. 5, the angle θ11 is smaller than the angle θ12.

The light source element LS1 is provided to face the edge GV1 of the light guide LG. The light LT emitted from the light source element LS1 enters from the surface containing the edge GV1 of the light guide LG and proceeds straight within the light guide LG. The light LT having reached the edge GV2 of the light guide LG is reflected downward by the reflector RFB provided at the edge GV2.

The light reflected by the reflector RFB is denoted as light LTB. The light LTB propagates in the opposite direction to the first direction X between the surface BS and surface US of the light guide LG while satisfying the condition for the total reflection.

Light LT and light LTB, having a beam width d1, propagate inside the light guide LG. The light LTB, which has a beam width d1, is emitted upward by a protruding portion (prism) provided on the surface BS. This emitted light is designated as light RL. The light RL is emitted upward from the surface US of the light guide LG and enters the prism sheet PRS. The light RL is further emitted upward from the illumination device ILDr as light DL, emitted along the third direction Z by the prism sheet PRS.

The acute angle formed by the surface BS and the edge GV2 is denoted as an angle t1. The acute angle formed by a virtual line extending the surface BS along the first direction X and the edge GV2 is denoted as an angle t2. The angle formed by the surface BS and the light RL is denoted as an angle t3.

Here, note that even after reflecting off the surface BS of the light guide LG, part of the light LTB does not exit upward from the surface BS, but is totally reflected at the surface US and returns to the light guide LG. The light LTB, after undergoing total reflection at the surface US and returning to the light guide LG, is totally reflected again at the surface BS. Thus, the light LTB is guided inside the light guide LG. When the amount of light LTB being continuously totally reflected is large, there is a risk that the utilization efficiency of the light LTB entering from the light source element LS1 may be deteriorated.

The region from where the light LTB is reflected by the surface US and thereafter it is reflected by the surface BS. is defined as a region NFR. In the region NFR, the light LTB having a beam width d1 is not reflected, and therefore the light is not lifted upward.

The region of the surface US, where the light DL is emitted is defined as a region RLR. On the other hand, in correspondence to the region NFR, a region NLR where light is not emitted is formed on the surface US. That is, on the surface US, a bright region RLR where the light DL is emitted and a dark region NLR where the light DL is not emitted are formed.

The distance corresponding to the region NFR along the first direction X is defined as a distance (length) LD2. The distance LD2 is the distance corresponding to the region NLR as well. The distance of the region RLR along the first direction X is defined as a distance (length) LL1. Between the end portion of the light guide LG on the right side of the page and the region where the light DL is irradiated near the edge GV2, no light irradiation occurs. This area is designated as an area NNR. The distance of the region NNR along the first direction X is defined as a distance LD1.

The distances LL1, LD1, and LD2 are expressed by the following equations.

$$LL 1 = d 0 ( ( 1 / tan t 1 ) + ( 1 / tan t 1 ) ) \qquad ( Equation 1 )$$

$$LD 1 = d 0 / ( tan t 3 ) \qquad ( Equation 2 )$$

$$LD 2 = d 0 ( ( 1 / tan t 2 ) - ( 1 / tan t 1 ) ) \qquad ( Equation 3 )$$

$$t 2 = 2 ( 90 ° - t 1 ) \qquad ( Equation 4 )$$

$$t 3 = t 2 + 011 \qquad ( Equation 5 )$$

For example, the thickness d0 is set to 1 [mm] (d0=1). The angle t1 is set to 76.75° (t1=76.75°), and the angle θ11 is set to 15° (θ11=15°). From (Equation 4), the angle t2 is 26.5° (t2=26.5°). From (Equation 5), the angle t3 is 56.5° (t3=56.5°).

From (Equation 1) and (Equation 4), the distance LL1 is 2.24 [mm] (LL1=2.24). From (Equation 3) and (Equation 4), the distance LD2 is 1.77 [mm] (LD2=1.77).

In the embodiment, the protruding portion (prism) can be provided on the surface US of the light guide LG as well, and with this configuration, the light LTB guided inside the light guide LG can be emitted upward.

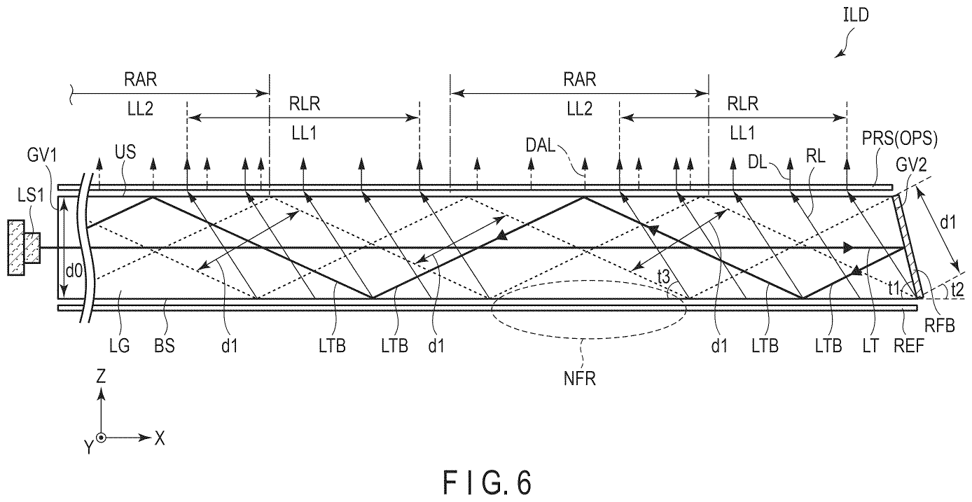

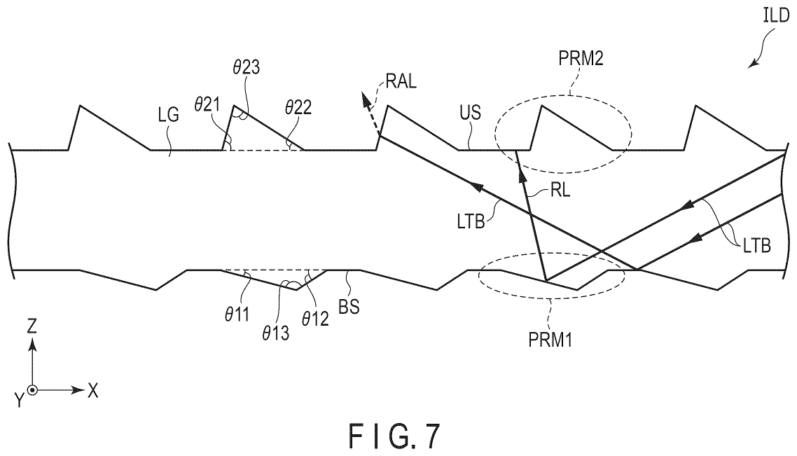

FIG. 6 is a cross-sectional view schematically showing a configuration of the illumination device of the embodiment. The illumination device ILD shown in FIG. 6 is different from the illumination device ILDr shown in FIG. 4 in that multiple convex portions PRM2 are provided on the surface US of the light guide LG. FIG. 7 is a cross-sectional view showing the protruding portions provided on the light guide LG.

As shown in FIG. 7, the light guide LG has not only the protruding portions PRM1 on the surface US, but also the protruding portions PRM2 on the surface BS. The protruding portions PRM2 are upwardly protruding portions. Of the base angles of the protruding portion PRM2, the angle on the left side of the page is denoted as an angle θ21, and the angle on the right side of the page is denoted as an angle θ22. The apex angle of the protruding portion PRM2 is denoted as an angle θ23. The angles θ21, θ22, and θ23 may be different from each other. In the example shown in FIG. 7, the angle θ21 is larger than the angle θ22. Further, the angle θ21 of the protruding portion PRM2 is larger than the angle θ11 of the protruding portion PRM1. The angle θ23 of the protruding portion PRM2 is larger than the angle θ13 of the protruding portion PRM1.

As shown in FIG. 6, and as well as in the case of FIG. 4, the light LT emitted from the light source element LS1 enters from the surface containing the edge GV1 of the light guide LG and propagates inside the light guide LG. The light LT reaching the edge GV2 of the light guide LG is reflected downward by the reflector RFB. The reflected light LTB is totally reflected repeatedly between the surface BS and the surface US of the light guide LG and propagates in the opposite direction to the first direction X.

The light LTB reflected at the surface BS of the light guide LG is emitted upward by a protruding portion (prism) provided on the surface BS. This emitted light RL exits from the surface US of the light guide LG and enters the prism sheet PRS. The light RL is further emitted upward from the illumination device ILD by the prism sheet PRS as light DL emitted along the third direction Z.

As described in FIG. 4, the light LTB reflects at the surface US and returns to the light guide LG. The light LTB undergoes total reflection at the surface US, and returns to inside the light guide LG, and then is totally reflected further at the surface BS. The light LTB reflected at the surface BS propagates toward the surface US.

The light LTB reaching the surface US is emitted upward by the protruding portions PRM2 provided on the surface US. This emitted light is referred to as light RAL. The light RAL is emitted from the surface US of the light guide LG and enters the prism sheet PRS. The light RAL is further emitted upward from the illumination device ILD by the prism sheet PRS as light DAL, emitted along the third direction Z.

In the example shown in FIG. 6, the region NFR exists. But because the protruding portions PRM2 are provided on the surface US, the light LTB is emitted upward. With this configuration, the light LTB propagating through the light guide LG can be efficiently extracted.

The region where the light DAL is emitted is defined as a region RAR. In the illumination device ILD shown in FIG. 6, not only the region RLR where the light DL is emitted exist, but also the region RAR where the light DAL is emitted is formed as well. With this configuration, the amount of light emitted from the illumination device ILD is increased, and thus the light extraction efficiency is improved.

In the example shown in FIG. 6, a part of the region RAR overlaps with the region RLR. Note here that the embodiment is not limited to this. The region RAR may be disposed to be apart from the region RLR without overlapping therewith. Further, the entire region RAR may overlap with the region RLR. The positions of the region RLR and region RAR with respective to each other can be controlled by varying the angles of the edge GV2 and the reflector RFB relative to the X-Y plane, the angles θ21, θ22, and θ23 of the protruding portion PRM2, the refractive index of the light guide LG and the like.

The distance of the region RAR, where the light DAL is irradiated, along the first direction X is defined as a distance (length) LL2.

The distance LL2 is expressed by the following equation.

$$LL 2 = d 0 ( ( 1 / tan t 2 ) - ( 1 / tan t 3 ) ) \qquad ( Equation 6 )$$

As in the case of FIG. 4, in FIG. 6 as well, for example, the thickness d0 is 1 [mm] (d0=1). The angle t1 is set to 76.75° (t1=76.75°), and the angle θ11 is set to 15° (θ11=15°). The angle θ21 is set to 78.5° (θ21=78.5°). From (Equation 4), the angle t2 is 26.5° (t2=26.5°). From (Equation 5), the angle t3 is 56.5° (t3=56.5°).

Here, from (Equation 4), (Equation 5), and (Equation 6), the distance LL2 is 1.34 [mm] (LL2=1.34).

With the embodiment, it is possible to obtain an illumination device having improved light extraction efficiency. With such an illumination device thus provided, a display device having high brightness can be obtained.

### Configuration Example 1

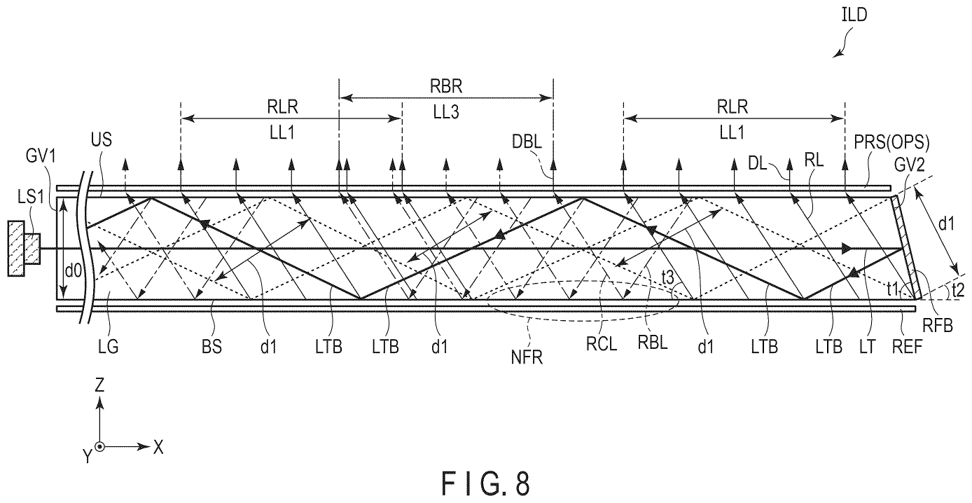

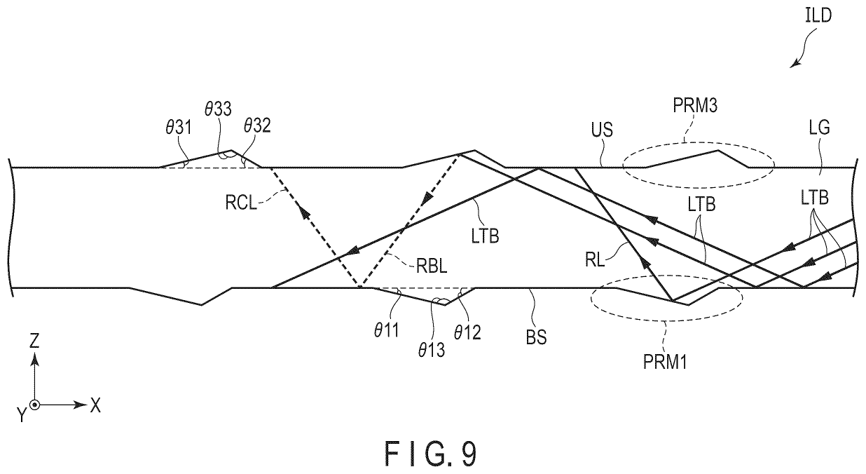

FIG. 8 is a cross-sectional view showing another configuration example of the illumination device in the embodiment. The configuration example shown in FIG. 8 is different from the configuration example shown in FIG. 6 in that it has a protruding portion (prism) that reflects light downward. FIG. 9 is a cross-sectional view showing the protruding portion provided on the light guide.

As shown in FIG. 9, not only the protruding portion PRM1 on the surface BS, but also the protruding portion PRM3 on the surface US are provided on the light guide LG. The protruding portion PRM3 is an upwardly protruding portion. Of the base angles of the protruding portion PRM3, the angle on the left side of the page is denoted as an angle θ31, and the angle on the right side of the page is denoted as an angle θ32. The apex angle of the protruding portion PRM3 is denoted as an angle θ33. The angles θ31, θ32, and θ33 may be different from each other. In the example shown in FIG. 9, the angle θ31 is smaller than the angle θ32.

In Configuration Example 1, the protruding portion PRM1 and protruding portion PRM3 are disposed in a line-symmetric relationship with respect to the first direction X. The angle θ11 of the protruding portion PRM1 and the angle θ31 of the protruding portion PRM3 are equal to each other. The angle θ12 of the protruding portion PRM1 and the angle θ32 of the protruding portion PRM3 are equal to each other. The angle θ13 of the protruding portion PRM1 and the angle θ33 of the protruding portion PRM3 are equal to each other.

As shown in FIG. 8, and as well as in the case of FIG. 4, the light LT emitted from the light source element LS1 enters from the surface of the light guide plate LG containing the edge GV1 and propagates inside the light guide LG. The light LT reaching the edge GV2 of the light guide LG is reflected downward by the reflector RFB. The reflected light LTB is totally reflected repeatedly between the surface BS and surface US of the light guide LG and propagates in the direction opposite to the first direction X.

The light LTB reflected at the surface BS of the light guide LG reaches the surface US. The light LT reaching the surface US is emitted downward by the protruding portion PRM3 provided on the surface US. This downward emitted light is referred to as light RBL. The light RBL enters the region NFR.

The region NFR, as explained in FIG. 4, is a region into which the light LTB having a beam width d1 does not enter. In FIG. 8, the light RBL enters the region NFR as well. The light RBL is emitted upward by the protruding portion PRM1 provided in the region NFR (surface BS). This upwardly emitted light is referred to as light RCL.

The light RCL, as well as in the case of the light RL, is emitted upward from the surface US of the light guide LG and enters the prism sheet PRS. The light RCL is further emitted upward from the illumination device ILD by the prism sheet PRS as light DBL, which is emitted along the third direction Z.

In Configuration Example 1, the light LTB propagating through the light guide LG is reflected downward by the protruding portion PRM3 provided on the surface US. The downwardly reflected light RBL is emitted upward by the protruding portion PRM1 provided on the surface BS. It is further emitted upward from the illumination device ILD as light DBL. With this configuration, the light LTB propagating through the light guide LG can be efficiently extracted.

The region where the light DBL is emitted is defined as a region RBR. In the illumination device ILD shown in FIG. 8, not only the area RLR where the light DL is emitted, but also the area RBR where the light DBL are formed. With this configuration, the amount of light emitted from the illumination device ILD is increased and the light extraction efficiency is improved.

In the example shown in FIG. 8, part of the region RBR overlaps with the region RLR. Note that the embodiment is not limited to this. The region RBR may be disposed apart from the region RLR without overlapping therewith. Alternatively, the entire region RBR may overlap with the region RLR. The positions of the region RLR and region RBR can be controlled by varying the angles of the edge GV2 and the reflector RFB relative to the X-Y plane, the angles θ31, θ32, and θ33 of the protruding portion PRM3, the refractive index of the light guide LG, and the like.

The distance of the region RBR where the light DBL is irradiated along the first direction X is defined as a distance (length) LL3.

The distance LL3 is expressed by the following equation.

$$LL 3 = d 0 ( ( 1 / tan t 2 ) - ( 1 / tan t 3 ) ) \qquad ( Equation 7 )$$

For example, as well as in the case of FIG. 4, the thickness d0 is set to 1 [mm] (d0=1). The angle t1 is set to 76.75° (t1=76.75°), and the angle θ11 is set to 15° (θ11=15°). The angle θ31 is set to 15° (θ31=15°). From (Equation 4), the angle t2 is 26.5° (t2=26.5°). From (Equation 5), the angle t3 is 56.5° (t3=56.5°).

From (Equation 4), (Equation 5), and (Equation 7), the distance LL3 is 1.34 mm (LL33=1.34).

With Configuration Example 1, an illumination device with improved light extraction efficiency can be obtained. With such an illumination device thus provided, a display device having high brightness can be obtained.

### <Configuration Example 2>

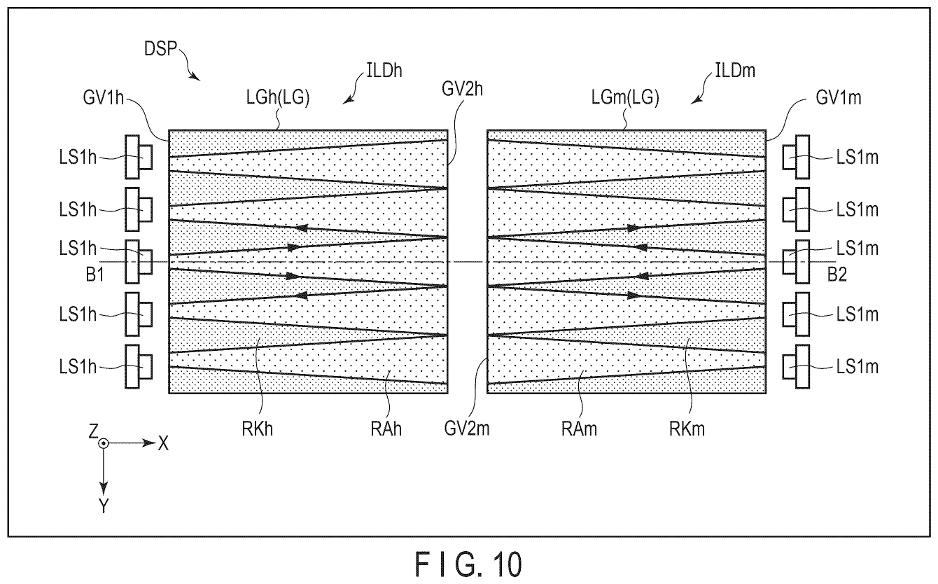

FIG. 10 is a plan view illustrating an example of an application of the illumination device. The display device DSP shown in FIG. 10 includes an illumination device ILDh for the left eye and an illumination device ILDm for the right eye.

The illumination device ILDh for the left eye has a configuration similar to the illumination device ILD shown in FIG. 2. In FIG. 10, the illumination device ILDh comprises a light guide LGh and a plurality of light source elements LS1h. In a plan view, the edges of the light guide LGh, which extend along the second direction Y are designated as an edge GV1h and an edge GV2h, respectively. In FIG. 10, the edge on the left side of the page is designated as the edge GV1h, and the edge on the right side of the page is designated as the edge GV2h. The light source elements LS1h are located at respective positions facing the edge GV1h of the light guide LGh.

The illumination device ILDm for the right eye is disposed line-symmetrically with respect to the second direction Y relative to the illumination device ILDh. As shown in FIG. 10, the illumination device ILDm comprises a light guide LGm and a plurality of light source elements LS1m. In a plan view, the edges of the light guide LGm, which extend along the second direction Y are designated as an edge GV1m and an edge GV2m, respectively. In FIG. 10, the edge on the right side of the page is referred to as the edge GV1m, and the edge on the left side of the page is referred to as the edge GV2m. The light source elements LS1m are provided at respective positions facing the edge GV1m of the light guide LGm.

As shown in FIG. 10, for example, the light emitted from the light source elements LS1h (corresponding to light LT), and the light emitted upward from the light guide LGh (corresponding to light DL, light DAL, and light DBL) are synthesized. With this configuration, bright regions RAh and dark regions RKh are formed on the light guide LGh. The width of each bright region RAh becomes narrower as the location is closer to the respective light source element LS1h. The width of each bright region RAh becomes wider as the location is farther away from the respective light source element LS1h.

Similarly, the light emitted from the light source elements LS1m, and the light emitted upward from the light guide LGm are synthesized. With this configuration, bright regions RAm and dark regions RKm are formed in the light guide LGm. The width of each bright region RAm becomes narrower as the location is closer to the respective light source element LS1m. The width of each bright region RAm becomes wider as the location is farther away from the respective light source element LS1m.

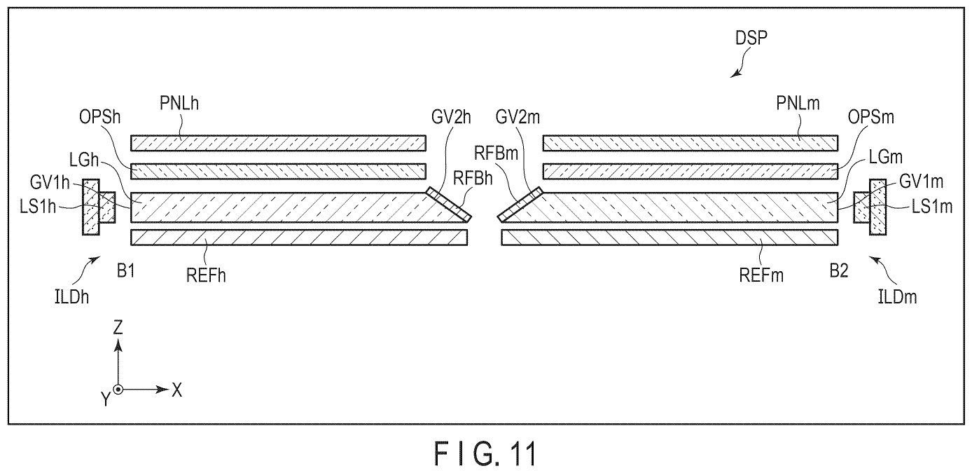

FIG. 11 is a cross-sectional view showing the cross-sectional structure of the display device taken along the line B1-B2 in FIG. 10. The display device DSP comprises an illumination device ILDh, a display panel PNLh, an illumination device ILDm, and a display panel PNLm. The display panel PNLh is provided on the illumination device ILDh. The display panel PNLm is provided on the illumination device ILDm.

The illumination device ILDh and display panel PNLh have configurations similar to those of the illumination device ILD and display panel PNL shown in FIG. 3. The illumination device ILDm and display panel PNLm are provided symmetrically with respect to the Y-Z plane relative to the illumination device ILDh and display panel PNLh.

The illumination device ILDh comprises a reflector REFh, a light guide LGh, a reflector RFBh, an optical sheet OPSh, and a light source element LS1h. The reflector REFh, the light guide LGh, and the optical sheet OPSh are stacked in this order.

The light guide LGh has an edge GV1h and an edge GV2h. The edge GV1h is located on the left side of the page and faces the light source element LS1h. The edge GV2h is located on the right side of the page and faces the edge GV2m of the light guide LGm.

The illumination device ILDm comprises a reflector REFm, a light guide LGm, a reflector RFBm, an optical sheet OPSm, and a light source element LS1m. The reflector REFm, the light guide LGm, and the optical sheet OPSm are stacked in this order.

The light guide LGm has an edge GV1m and an edge GV2m. The edge GV1m is located on the right side of the page and faces the light source element LS1m. The edge GV2m is located on the left side of the page and faces the edge GV2h of the light guide LGh.

The cross-sectional shape of each of the light guide LGh and the light guide LGm is trapezoidal in which the upper base is shorter than the lower base. The reflector REFm and the reflector RFBm are located to face each other.

For the illumination device ILDh and illumination device ILDm, the illumination device ILD described above may be used. That is, on the light guide LGh and light guide LGm, a protruding portion PRM2 or PRM3 is provided. More specifically, for the illumination device ILDh including the light guide LGh, a configuration similar to that of the illumination device ILD described above may be used. On the other hand, for the illumination device ILDm including the light guide LGm, it suffices if it has a configuration that is left-right symmetrical with respect to the Y-Z plane compared to the above-described illumination device ILD.

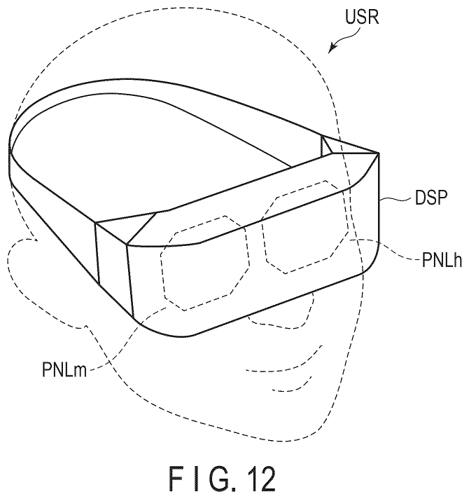

FIG. 12 is a perspective view showing an example of the appearance of the display device according to Configuration Example 3. In Configuration Example 3, the display device DSP includes a head-mounted display (HMD), which is mounted on the head of the user when used. The display device DSP having such a configuration is used to provide, for example, virtual reality (VR) to a user USR wearing the display device DSP on the head.

The display panel PNLh and the display panel PNLm are respectively disposed so that they are located in front of the left eye and right eye, respectively, of the user USR when the user USR has the display device DSP mounted on the head.

As described above, with the illumination devices with high light extraction efficiency, it is possible to obtain a display device with high brightness.

In this disclosure, the edge GVL1 and the edge GV2 of the light guide LG may as well be referred to as the first edge and the second edge, respectively. The surface BS of the light guide LG may as well be referred to as the first surface, and the surface US may be referred to as the second surface. The reflector REFm and the reflector RFBm are may be referred to as the first reflector and the reflector, respectively.

The protruding portion PRM1 may be referred to as the first protruding portion, and the protruding portion PRM2 or protruding portion PRM3 may be referred to as the second protruding portion. The cross-sectional shape of the protruding portion PRM1 may be referred to as the first triangular. The angles θ11, θ12, and θ13 of the protruding portion PRM1 may be referred to as the first base angle, the second base angle, and the first apex angle, respectively.

The cross-sectional shape of the protruding portion PRM2 and protruding portion PRM3 may be referred to as the second triangular. That is, the cross-sectional shape of the protruding portion PRM2 or PRM3 can be said as polygonal.

The angles θ21, θ22, and θ23 of the protruding portion PRM2 may be referred to as the third base angle, the fourth base angle, and the second apex angle, respectively. The angles θ31, θ32, and θ33 of the protruding portion PRM3 may be referred to as the third base angle, the fourth base angle, and the second apex angle, respectively.

Note that the ordinal numbers assigned to the edges and angles are not limited to those listed above. Different ordinal numbers may be assigned as necessary.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is

1. An illumination device comprising:
a light guide including a first edge and a second edge;
a plurality of light source elements disposed to face the first edge;
a first reflector provided below the light guide;
an optical sheet provided on the light guide; and
a second reflector provided in contact with the second edge,
wherein
the light guide has a cross-sectional shape of a trapezoid whose upper base is shorter than a lower base,
the light guide includes a first surface facing the first reflector and a second surface facing the optical sheet,
the first surface includes a plurality of first protruding portions formed thereon,
the second surface includes a plurality of second protruding portions formed thereon,
each of the plurality of first protruding portions has a cross-sectional shape of a first triangle projecting downward,
each of the plurality of first protruding portions has a first base angle, a second base angle, and a first apex angle,
each of the plurality of second protruding portions has a cross-sectional shape of a second triangle projecting upward,
each of the plurality of second protruding portions has a third base angle, a fourth base angle, and a second apex angle,
the third base angle is larger than the first base angle.

2. The illumination device according to claim 1, wherein
the second apex angle is larger than the first apex angle.

3. A display device comprising:
the illumination device according to claim 1, and
a display panel provided on the illumination device.

4. An illumination device comprising:
a light guide including a first edge and a second edge;
a plurality of light source elements disposed to face the first edge;
a first reflector provided below the light guide; and
an optical sheet provided on the second light guide; and
a second reflector provided in contact with the second edge,
wherein
the light guide has a cross-sectional shape of a trapezoid whose upper base is shorter than a lower base,
the light guide includes a first surface facing the first reflector and a second surface facing the optical sheet,
the first surface includes a plurality of first protruding portions formed thereon,
the second surface includes a plurality of second protruding portions formed thereon,
each of the plurality of first protruding portions has a cross-sectional shape of a first triangle projecting downward,
each of the plurality of first protruding portions has a first base angle, a second base angle, and a first apex angle,
each of the plurality of second protruding portions has a cross-sectional shape of a second triangle projecting upward,
each of the plurality of second protruding portions has a third base angle, a fourth base angle, and a second apex angle, and
the third base angle and the first base angle are equal to each other.

5. The illumination device according to claim 4, wherein
the fourth base angle and the second base angle are equal to each other, and
the second apex angle and the first apex angle are equal to each other.

6. A display device comprising:
the illumination device according to claim 4; and
a display panel provided on the illumination device.
